(19) United States
(12) Patent Application Publication
(10) Pub. No.: US 2026/0030459 A1
(43) Pub. Date: Jan. 29, 2026

(54) METHOD FOR BIDIRECTIONAL TRANSLATION BETWEEN SIGN LANGUAGE AND TEXT USING AI, DEEP LEARNING, AND DICTIONARY SEARCH TECHNIQUES

(71) Applicant: Ahmed Mahgoub, Roswell, GA (US)

(72) Inventors: Ahmed Mahgoub, Roswell, GA (US); Amira Ebeid, Roswell, GA (US)

(21) Appl. No.: 18/784,082

(22) Filed: Jul. 25, 2024

(51) Int. Cl. G06F 40/58; G06V 40/20

(52) U.S. Cl. CPC G06F 40/58; G06V 40/28

(57) ABSTRACT

The present invention facilitates communication between sign language users and machines by translating sign language and text using AI models, deep learning computer vision, and word embeddings. Users interact via sign language, captured and processed through deep learning and NLP modules. The system converts sign language videos into text, constructs coherent sentences, and generates contextually appropriate responses using a Retrieve and Generate (RAG) model. Responses are translated back into sign language videos, spelling out words not found in the dictionary. If requested, a human agent can respond. Key features include high-accuracy recognition, context-aware response generation, dynamic vocabulary updates, and optional human interaction. The method ensures efficient processing with LLM, embedding techniques, and deep learning, optimizing translation accuracy and user experience. The system adapts to multiple languages and dialects by training on specific sign languages, making it applicable globally.

### FIELD OF THE INVENTION

The present invention relates to methods for enabling automatic bidirectional translation between sign language and text, utilizing advanced artificial intelligence (AI), deep learning computer vision, and natural language processing (NLP) technologies. The invention addresses the communication barriers faced by sign language users by providing a comprehensive solution for real-time, context-aware translation. This method includes sophisticated dictionary search techniques and mechanisms for handling new words by spelling them out letter by letter, with the ability to update the sign language dictionary. The method is adaptable to multiple sign languages and dialects, making it applicable to a global audience and enhancing inclusivity in various communication settings. By combining the precision of AI with the richness of sign language, the invention significantly improves the communication experience for all users.

### BACKGROUND

Communication between hearing individuals and those who are deaf or hard of hearing often presents challenges, particularly in environments where sign language is the primary mode of communication. Traditionally, communication relies heavily on interpreters or text-based methods, which can be inefficient and lack the nuances of a natural conversation. As the demand for more inclusive communication methods grows, there is a clear need for systems that facilitate real-time, seamless interactions across different modes of communication.

Despite advances in technology, there are still significant barriers to effective communication in sign language. Current solutions often require expensive equipment or skilled interpreters, which are not always readily available. Moreover, existing automated systems for sign language translation are often limited in their ability to accurately capture the context and nuances of the language, leading to misunderstandings and frustration.

This invention addresses these challenges by introducing a system that enables two-way video communication between individuals and machines or devices. By leveraging advanced machine learning models and a comprehensive sign language dictionary, the system establishes a dynamic and interactive communication pathway using sign language. This approach allows for seamless and natural interaction, empowering sign language users to engage effectively with machines and devices in a more intuitive and accessible manner.

### SUMMARY

The invention presents a comprehensive method for implementing an automatic sign language video conversation system, enabling bidirectional translation between sign language and text using word embeddings and AI models. The system captures video input of a user performing sign language gestures, processes the video to identify individual sign language words, and converts these gestures into corresponding sign language words using a trained computer vision model. Once the sign language words are identified, a sentence reconstruction engine converts them into a coherent sentence. It is important to note that the sentences coming from the sign language may be simplified or not complete either because the dictionary does not exhaustively contain all the signs or because sign language itself does not provide a word-for-word match with the spoken or written language. This ensures that the constructed sentences are as accurate and meaningful as possible, given the limitations of the available sign language vocabulary.

The system then utilizes a fine-tuned large language model (LLM) to generate responses based on the reconstructed sentence. These responses are derived from querying a document or database using a Retrieve and Generate (RAG) model. The responses are simplified according to the structural specifications of sign language, focusing on key verbs and nouns, and to match the existing words in the dictionary, to ensure clarity and relevance in communication. Additionally, if the user requests a human agent, the coherent sentence is sent to the human agent for response, integrating human interaction into the workflow as needed.

Tokenization and embedding units represent the simplified sentence in semantic-rich word embeddings, which are mapped to a predefined set of sign language words. The sign language translation engine converts these mapped embeddings into a sequence of sign language images, which are then used to construct a video. This video is displayed to the user, allowing them to see the complete sentence visually in sign language.

For words not found in the dictionary, the system employs a sophisticated dictionary search technique. The non-matching word handling unit spells out these words letter by letter, with the capability to update the sign language dictionary as needed. This ensures that the system can continuously learn and adapt to new vocabulary, enhancing its ability to provide accurate translations over time.

This approach facilitates real-time, bidirectional communication, reduces misunderstandings, and enhances inclusivity for sign language users in various communication settings. By training the computer vision model on specific sign languages and providing the corresponding LLM and embedding models, the system is adaptable to multiple languages and dialects. By combining the precision of Al with the richness of sign language, this invention significantly improves the communication experience for all users.

### BRIEF DESCRIPTION OF FIGURES

Embodiments of the present disclosure are illustrated in the following drawings to facilitate a clear understanding of the principles of the invention and are not necessarily drawn to scale.

FIG. 1 is a flowchart illustrating the overall system architecture for automatic sign language video conversation translation according to various embodiments of the present disclosure.

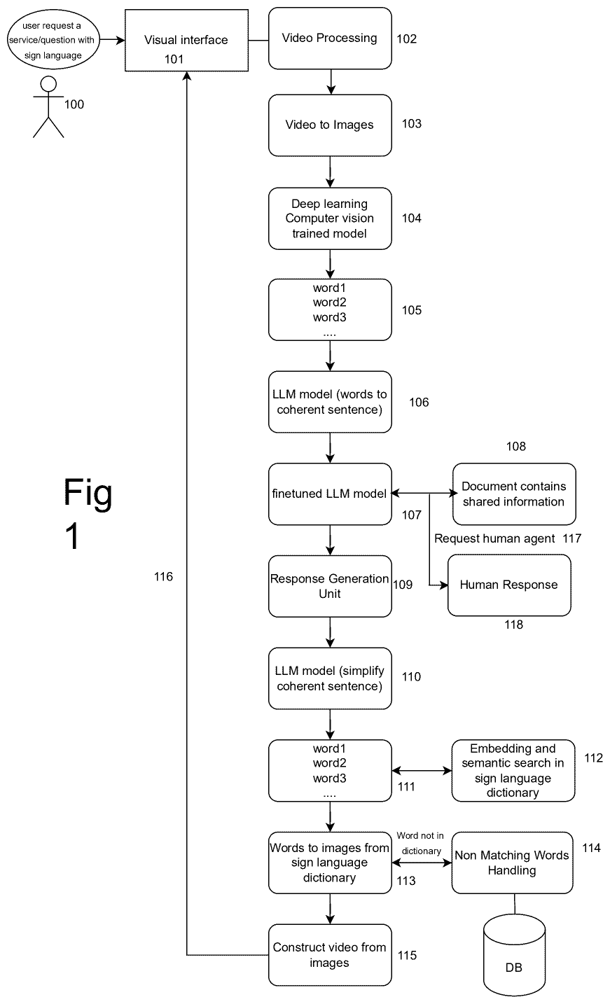

FIG. 2 is a diagram showing the process of embedding sign language words and finding the nearest matched sign language word for accurate translation according to various embodiments of the present disclosure.

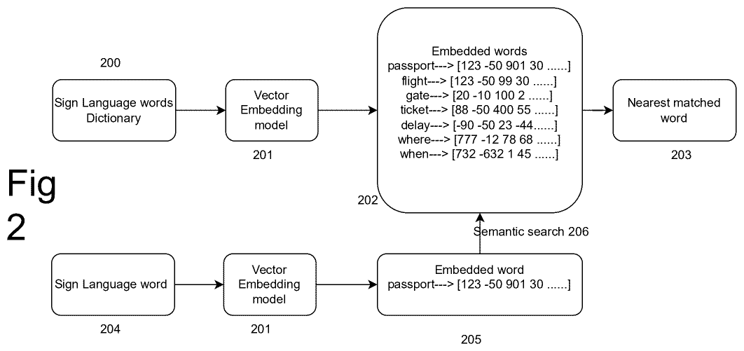

FIG. 3 is a diagram detailing the handling of new words that are not present in the sign language dictionary according to various embodiments of the present disclosure.

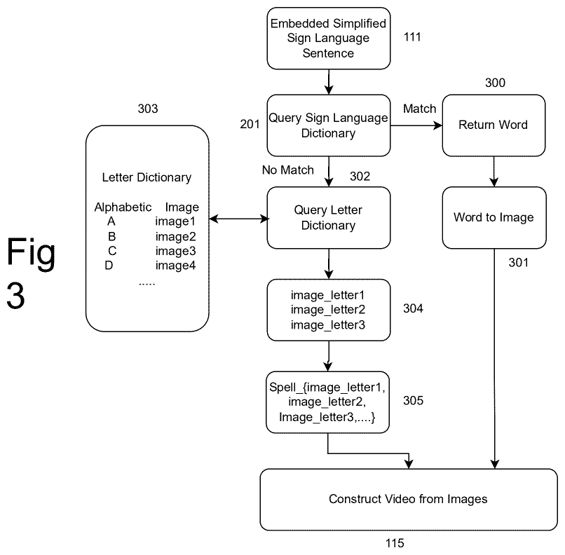

FIG. 4 is a schematic block diagram that provides an example illustration of the computing environment and major components involved in the system according to various embodiments of the present disclosure.

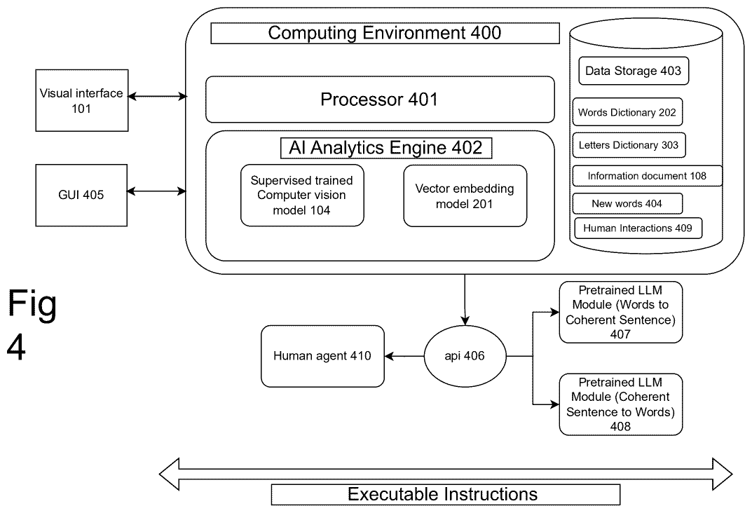

### DETAILED DESCRIPTION OF THE INVENTION

This section provides an extensive description of the system designed for automatic sign language video conversation translation, referencing the associated block diagrams for clarity. The primary objective of this system is to facilitate seamless communication between sign language users and machines by translating complete sentences into Sign Language using advanced Al models and word embeddings. This system addresses the current limitations in sign language translation by providing a more accurate, context-aware, and efficient solution.

System Overview: The system is designed to capture video input of a user performing sign language gestures, process the video to identify individual sign language words, convert these gestures into corresponding sign language words using a trained computer vision model, and reconstruct these words into coherent sentences. The system then generates responses based on the reconstructed sentences, simplifies these responses, and converts them into sign language videos. If the user requests a human agent, the system sends the coherent sentence to the human agent for response via the Human Agent interaction API 410. The system includes several interconnected modules, each playing a crucial role in the translation process.

Visual Data Capture Module (Block 101): Executable instructions 307 stored on a non-transitory computer-readable storage medium cause the Video Capture Module 101 to capture video input from a user performing sign language gestures. The captured video serves as the initial input for the system, allowing for the extraction of sign language components. This module ensures that high-quality video is captured for accurate analysis. The video capture module includes a camera interface and preprocessing units to enhance video quality 102.

Visual Data to Image Conversion Unit (Block 103): Executable instructions 307 stored on a non-transitory computer-readable storage medium cause the Video to Image Conversion 103 to process the captured video and convert it into a series of images. These images are essential for further analysis and recognition of individual sign gestures. The conversion unit employs frame extraction techniques to ensure that each significant gesture is captured in the image sequence.

Deep Learning Visual Recognition Device (Block 104): Executable instructions 307 stored on a non-transitory computer-readable storage medium cause the Deep Learning Image to Word Recognition Module 104 to analyze the images from Block 103 to identify specific sign language words. The deep learning model 104 is trained to recognize various sign gestures and convert them into corresponding words. This module includes a convolutional neural network trained on a vast dataset of sign language images to achieve high accuracy in word recognition.

Word Pool (Block 105): Executable instructions 307 stored on a non-transitory computer-readable storage medium cause the Word Pool 105 to collect the words identified by the recognition module 104, creating a pool of sign language words that are used for sentence construction. The word pool acts as a temporary storage unit, ensuring that all identified words are readily available for the next stages of processing.

API LLM Words to Sentence Converter (Block 106): Executable instructions 307 stored on a non-transitory computer-readable storage medium cause the API LLM Words to Sentence Converter 106 to construct coherent sentences from the identified words. The API-based language model (LLM) 203 is employed to ensure that the words are organized logically and meaningfully. This module leverages natural language processing (NLP) techniques to generate syntactically and semantically correct sentences. This process also addresses scenarios where certain words may be missing due to the unavailability of the word in the sign language dictionary or the sign language itself. The module fills in these gaps by using context and available data to construct a complete and coherent sentence, ready for further processing by the RAG (Retrieve and Generate) model.

LLM RAG (Retrieve and Generate) Module (Block 107): Executable instructions 307 stored on a non-transitory computer-readable storage medium cause the LLM RAG (Retrieve and Generate) Module 107 to process the constructed sentence from Block 106 and generate an appropriate response. This module accesses a database 108 (e.g., PDF documents) to retrieve relevant information, ensuring that the responses are contextually appropriate and informative.

Response Generation Device (Block 109): Executable instructions 307 stored on a non-transitory computer-readable storage medium cause the Answer Generation Unit 109 to receive the generated response from the LLM RAG Module 107. The unit then saves the response in temporary memory to be used as feedback for the ongoing conversation. Additionally, if the user requests a human agent 117, the coherent sentence is sent to the human agent for response via the Human Agent interaction API 410. The answer is then sent to an output display unit or a graphical user interface (GUI) if applicable, allowing the user to view the response in real-time. This ensures that the communication is effective, and that the user receives timely feedback.

Sign Language Word Selection Module (Block 111): Executable instructions 307 stored on a non-transitory computer-readable storage medium cause the Sign Language Word Selection Module 111 to use NLP models to convert the generated answer into a set of words most used in sign language. Unnecessary words are dropped to align the answer with sign language vocabulary. This module ensures that the output is simplified for easier translation into sign language.

Word Embedding and Matching Module (Block 112): Executable instructions 307 stored on a non-transitory computer-readable storage medium cause the Word Embedding and Matching Module 112 to vector embed each word selected in Block 111 using NLP embedding models such as Word2Vec, GloVe, or BERT. This embedding process helps find the best match for each word with the provided sign language dictionary. The module captures the semantic richness of the words to facilitate accurate matching.

Embedding Part (Blocks 201, 202, 203, 205): The diagram illustrates the process of embedding and matching process to find the nearest matched sign language word for accurate sign language translation.

Vector Embedding Model (Block 201): The system includes a vector embedding model 201 that converts both the sign language words dictionary 200 and individual sign language words 204 into their corresponding vector representations. This process captures the semantic and contextual nuances of each word. The vector embedding model transforms the input words and dictionary entries into embedded vectors, ensuring that they share a common vector space.

Sign Language Words Dictionary (Block 200): The sign language words dictionary 200 contains a collection of sign language words. These words are transformed into their corresponding embedded vectors using the vector embedding model 201. The dictionary entries, once embedded, are stored in the embedded words database 202.

Embedded Words Database (Block 202): The embedded words database 202 stores the vector representations of the sign language words from the dictionary. Each entry includes an embedded vector, capturing the semantic and contextual details of the word. For example:
passport--> [123 −50 901 30 . . . ]
flight--> [123 −50 99 30 . . . ]
gate--> [20 −10 100 2 . . . ]
ticket--> [88 −50 400 55 . . . ]
delay--> [−90 −50 23 −44 . . . ]
where--> [777 −12 78 68 . . . ]
when--> [732 −632 1 45 . . . ]
   The embedded words database also includes current data tables for storing ongoing translation data and historical data tables for archiving completed translations and user feedback. This structure ensures that both active and past translation efforts are well-documented, allowing for continuous refinement and accuracy improvements.

The data storage platform is crucial for managing the various types of data generated and used by the system. It includes:
a—Simplified Sentence Data: Intermediate data representing the simplified sentence before final translation.
b—Word Embeddings Data: Data representing the tokenized sentence in the form of word embeddings.
c—Mapping Data: Data reflecting the mapping of word embeddings to sign language words.
d—Translation Output Data: Data representing the final sequence of sign language words.
e—Letters table
d—Words table

To enhance the system's functionality, the data storage platform further includes:
a—Current Data Table: For storing ongoing translation data, ensuring that all active translations are up-to-date and accessible.
b—Historical Data Table: For archiving completed translations, new words, and user feedback, which helps in refining and improving the translation models over time.
c—Human Agent Interaction Data: For storing data related to interactions with human agents, ensuring that the responses provided by human agents are documented and accessible for future reference.

Semantic Search (Block 206): When a new sign language word 204 is received, it is converted into its vector representation using the vector embedding model 201. The embedded vector is then compared against the vectors stored in the embedded words database 202 using a similarity metric, such as cosine similarity or Euclidean distance, to measure the closeness between the embedded word and dictionary entries.

Nearest Matched Word (Block 203): The goal of the semantic search is to find the dictionary word whose vector is most similar to that of the input word, indicating a high semantic alignment. If the similarity exceeds a predefined threshold, the closest matching dictionary word is selected. This ensures that the most contextually and semantically appropriate sign language word is chosen, enabling accurate translation and representation in the sign language video output.

For instance, if the input word “passport” is embedded as [123 −50 901 30 . . . ], the system will find the closest match in the dictionary, which is “passport” with the same vector representation. If a word is not found in the dictionary, it will be spelled out letter by letter using the Letters Dictionary 303.

Embedded Word Example (Block 205): An example of this process is:
a—Input word “passport” is embedded to [123 −50 901 30 . . . ]
b—The system performs a semantic search against the dictionary entries in the embedded words database 202.
c—The nearest matched word, “passport,” is selected.

Handling New Words Using Letter Dictionary (Blocks 302, 303, 304, 305): When a new word is identified that is not present in the dictionary, the system spells out the word using individual letters from the Letters Dictionary (Block 303). The process involves the following steps:
a—The new word (Block 302) is broken down into its constituent letters.
b—Each letter is matched to its corresponding sign language image from the Letters Dictionary 303.
c—The images for each letter are assembled in sequence to represent the new word. Example: if the new word is “Wi-Fi”, W=image_letter1, I=image_letter2, F=image_letter3, I=image_letter2. The system spells out “Wi-Fi” by assembling the images for W, I, F, I.

For instance, if the input word “passport” is embedded as [123 −50 901 30 . . . ], the system will find the closest match in the dictionary, which is “passport” with the same vector representation. If a word is not found in the dictionary, it will be spelled out letter by letter using the Letters Dictionary 303.

Sign Language Image Sequencer (Block 113): Executable instructions 307 stored on a non-transitory computer-readable storage medium cause the Sequence of Sign Language Images 113 to convert the words from Block 111 into a sequence of sign language images. Each image corresponds to a sign language gesture, forming the basis for the visual output. This module includes a lookup mechanism to map words to their corresponding sign language images.

Video Sentence Construction Module (Block 115): Executable instructions 307 stored on a non-transitory computer-readable storage medium cause the Video Construction Module 115 to use the sequence of sign language images from Block 113 to construct a video that visually represents the entire sentence in sign language. The video is displayed to the user, completing the communication cycle. The module ensures smooth transitions between images to create a coherent video output.

Non-Matching Word Processor (Block 114): Executable instructions 307 stored on a non-transitory computer-readable storage medium cause the Non-Matching Word Processor 114 to process and spell out words that do not have corresponding sign language representations. It has the capability to update the sign language dictionary 201 as needed, ensuring that the system continuously improves its vocabulary coverage.

Feedback Loop System (Block 116): Executable instructions 307 stored on a non-transitory computer-readable storage medium cause the Feedback Loop System 116 to refine translations based on user input and contextual information. If the user requests a human agent 117, the system facilitates the interaction with the human agent who can provide responses based on the coherent sentences generated by the system via the Human Agent Interaction API 410. This system allows for continuous improvement of the translation accuracy, user satisfaction, and integrates human interaction when necessary.

Human Agent Interaction Management (Block 118): Executable instructions 307 stored on a non-transitory computer-readable storage medium cause the Human Agent Interaction Management 118 to handle interactions with human agents. When a user requests a human agent, the coherent sentence is sent to the human agent for response. The response from the human agent is then processed and integrated back into the system's workflow, allowing for seamless continuation of the conversation.

System Integration and Operation: The described system through its integrated modules provides a seamless method for translating sentences into sign language and displaying them as videos, thereby enhancing communication for sign language users. Each module is designed to interact efficiently with the others, ensuring a smooth and accurate translation process.

Computing Environment (Block 400): The system operates within a computing environment that includes processors, memory, storage, and network interfaces. Executable instructions 307 stored on a non-transitory computer-readable storage medium cause these components to support the execution of the various modules and ensure the scalability and reliability of the system.

AI Analytics Engine (Block 401): Executable instructions 307 stored on a non-transitory computer-readable storage medium cause the AI Analytics Engine 402 to harness the advanced capabilities of a Large Language Model (LLM), such as Llama 3, to enhance its natural language understanding and generation through an AI NLP analytics service. Upon structuring a user query 105 to the system's specifications, the system transmits this Structured Query 106 to the LLM AI NLP Service 402 via a secure Application Programming Interface (API) call 406. This API 406 facilitates seamless communication between the analytics and processing engine 401 and the LLM 407, enabling the system to exploit the model's extensive pre-trained knowledge and sophisticated language processing algorithms.

LLM Coherent Sentence Generation (Block 106): Executable instructions 307 stored on a non-transitory computer-readable storage medium cause the LLM Coherent Sentence Generation module 106 to process and assemble the words extracted from the video images using the deep learning model in Block 104 into coherent sentences. This is achieved through the API 406, which leverages an LLM Model 407, trained to convert a sequence of words into a syntactically and semantically coherent sentence. This conversion is crucial for accurately interpreting the user's input and generating relevant responses. The coherent sentence generated by the LLM Model 407 is then used to query the document 108 with a RAG (Retrieve and Generate) model to provide contextually appropriate and informative responses. This process ensures that the system can accurately interpret user inputs, generate contextually relevant responses, and continuously learn from user interactions to improve performance. The system is designed to support multiple languages and dialects, facilitating communication across diverse linguistic groups by training the computer vision model on the specific sign language and providing the corresponding LLM and embedding models.

LLM Sentence to Words Module (Block 408): Executable instructions 307 stored on a non-transitory computer-readable storage medium cause the LLM Sentence to Words Module 408 to convert the coherent sentences generated by the RAG model into individual words. This is achieved using an API 406 that leverages an LLM Model 408 trained for this specific task. The coherent sentences are deconstructed into their constituent words, preparing them for further processing.

Sign Language Words Selection (Block 111): Executable instructions 307 stored on a non-transitory computer-readable storage medium cause the Sign Language Words Selection Module 111 to use NLP models to convert the generated words into a set of words most commonly used in sign language. This is done by transmitting the words through the API 406, which communicates with an LLM Model 408. The API 406 facilitates the transmission of these words to the LLM Model 408, which processes the words and selects those most relevant for sign language translation. Unnecessary words are dropped to align the answer with sign language vocabulary, ensuring that the output is simplified for easier translation into sign language. This module ensures the selection of appropriate words that are contextually and semantically correct for sign language usage.

Data Storage (Block 403): Executable instructions 307 stored on a non-transitory computer-readable storage medium cause the Data Storage 403 to store all relevant data, including video inputs, images, recognized words, and generated responses. The storage system ensures that data is securely stored and readily accessible for processing.

Vector Embedding Model (Block 201): Executable instructions 307 stored on a non-transitory computer-readable storage medium cause the Vector Embedding Model 201 to transform words into their corresponding vector representations, capturing their semantic nuances. This model is critical for the embedding and matching processes.

Supervised Trained Computer Vision Model (Block 104): Executable instructions 307 stored on a non-transitory computer-readable storage medium cause the Supervised Trained Computer Vision Model 104 to recognize and predict sign language words from images. It plays a crucial role in converting video inputs into recognizable sign language words.

Letters Dictionary (Block 303): Executable instructions 307 stored on a non-transitory computer-readable storage medium cause the Letters Dictionary 303 to map individual letters to their corresponding sign language images, allowing the system to spell out words when necessary.

Words Dictionary (Block 202): Executable instructions 307 stored on a non-transitory computer-readable storage medium cause the Words Dictionary 202 to map words to their corresponding sign language images, facilitating the translation process.

New Words (Block 404): Executable instructions 307 stored on a non-transitory computer-readable storage medium cause the New Words 404 to handle the addition of new words to the dictionary, ensuring that the system's vocabulary remains up-to-date. These new words are sent to the operator of the system, who, with the help of experts, searches for the most suitable sign language for each new word and updates the dictionary accordingly. This process also facilitates the incorporation of new signs introduced over time to describe emerging words.

Human Agent Interaction Data (Block 409): Executable instructions 307 stored on a non-transitory computer-readable storage medium cause the Human Agent Interaction Data 409 to manage and store data related to interactions with human agents. This includes recording the coherent sentences sent to human agents for response and the responses provided by human agents. This data is stored for future reference and can be used to improve the system's accuracy and performance, ensuring that human interactions are well-documented and integrated seamlessly into the system's workflow.

Information Document (Block 108): Executable instructions 307 stored on a non-transitory computer-readable storage medium cause the Information Document 108 to store shared information that is accessed by the LLM RAG module 107 for generating responses.

API (Block 406 and 410): Executable instructions 307 stored on a non-transitory computer-readable storage medium cause the API 406 and 410 to facilitate communication between the system's modules and external databases or services, supporting data retrieval, processing, and human agent interaction. The API 406 manages the primary data exchange for LLM functionalities, while API 410 specifically handles the interactions with human agents, ensuring seamless integration of human responses into the system workflow.

GUI (Block 405): Executable instructions 307 stored on a non-transitory computer-readable storage medium cause the Graphical User Interface 405 to provide a visual interface for users to interact with the system, view translations, and provide feedback if applicable.

Executable Instructions: The system includes executable instructions stored on a non-transitory computer-readable medium, ensuring that all components work together seamlessly to perform the translation process.

Conclusion: This system significantly improves the communication experience for sign language users by providing an accurate, context-aware, and efficient method for translating sentences into sign language. By leveraging advanced AI models and word embeddings, the system ensures high-quality translations and enhances inclusivity for sign language users in various communication settings.

### Example Use Case

User Input in Sign Language (Captured by Video Capture Module—Block 100): The user asks in sign language: “Airport services?”

Video to Image Conversion (Block 101): The Video Capture Module captures the user's sign language gestures and converts the video into a series of images representing each gesture.

Deep Learning Image to Word Recognition (Block 102): The images are processed by the deep learning model to identify specific sign language words: Image 1: “Airport”, and Image 2: “Services”. These identified words are collected into the Word Pool (Block 103).

API LLM Words to Sentence Converter (Block 104): The words from the Word Pool are constructed into a coherent sentence using the API-based language model: “What services are available at the airport?”

LLM RAG (Retrieve and Generate) Module (Block 105): The constructed sentence is processed by the LLM RAG module to generate an appropriate response. This module accesses a database of static information about the airport to retrieve relevant details. The response generated is: “The airport offers various services including lounges, restaurants, shops, and free Wi-Fi.”

Answer Generation Unit (Block 106): The response is saved in temporary memory to be used as feedback for the ongoing conversation. Additionally, the response is sent to an output display unit or a GUI for the user to view in real-time. The Generated Answer: “The airport offers various services including lounges, restaurants, shops, and free Wi-Fi.”

Sign Language Word Selection Module (Block 107): The generated answer is simplified and converted into a set of words most used in sign language: “Airport offers services lounges restaurants shops free Wi-Fi.”

Word Embedding and Matching Module (Block 108): Each word is embedded and searched in the dictionary for the best matching sign language word. Airport=Airport, Offers=Provides (Best match from the dictionary), Services=Services, Lounges=Lounges, Restaurants=Restaurants, Shops=Shops, Free=Free, Wi-Fi=(Not found in dictionary, so spelled out as W-I-F-I)

Sequence of Sign Language Images (Block 109): The words from the matching algorithm are converted into a sequence of sign language images, including the letters for “W-I-F-I”.

Video Construction Module (Block 110): Using the sequence of sign language images, the module constructs a video that visually represents the entire sentence in sign language, including the spelled-out word “Wi-Fi.”

The user sees a video in sign language saying: “Airport provides services lounges restaurants shops free W-I-F-I.”

1. A method for implementing an automatic sign language video conversation by translating complete sentences into Sign Language using word embeddings, comprising:
Input Capture Unit: for capturing video input from a user performing sign language gestures;
Sign Detection Module: for sampling the captured video to identify individual sign language words;
Computer Vision Model: for converting the sampled video images containing sign language gestures into corresponding sign language words;
Sentence Reconstruction Engine: for converting the identified sign language words into a coherent sentence;
AI LLM Response Module: utilizing a fine-tuned large language model (LLM) trained on specific data to generate responses based on the reconstructed sentence;
Sentence Simplification Module: utilizing a pre-trained large language model (LLM) accessed via an application programming interface (API) to simplify the reconstructed sentence, focusing on key verbs and nouns, and removing complex or unnecessary phrases, and ensuring the use of existing words in the provided dictionary;
Tokenization and Embedding Unit: for tokenizing the simplified sentence and representing it using word embeddings that capture semantic relationships between words;
Embedding Transformation Module: for mapping the word embeddings to a predefined set of sign language words using a trained model, accommodating variations in sentence structure and context;
Sign Language Translation Engine: for converting the mapped embeddings into a sequence of sign language words;
Sign Language Dictionary Module: for mapping the sign language words to images of sign language gestures using a predefined sign language dictionary;
Video Construction Module: for constructing a video from the sequence of sign language images to be displayed to the user, enabling them to see the complete sentence;
Feedback Loop System: for refining translations based on user input and contextual information;
Non-Matching Word Handling Unit: for spelling out words that do not have corresponding sign language words, with the capability to replace spelling with the sign when the word is added to the dictionary.

2. The method of claim 1, wherein the word embedding model is a pre-trained model selected from the group consisting of NLP embedding models, such as Word2Vec, GloVe, and BERT, and is fine-tuned on a corpus of text to capture language-specific nuances.

3. The method of claim 1, wherein the mapping algorithm developed for translating word embeddings into corresponding sign language words considers semantic similarity and grammatical structure specific to Sign Language.

4. The method of claim 1, wherein the sentence simplification module, embedding transformation module, and sign language translation engine are integrated into a unified processing system, enabling seamless translation from input sentence to sign language output.

5. The method of claim 1, further comprising a data storage platform for storing:
Simplified Sentence Data: intermediate data representing the simplified sentence;
Word Embeddings Data: data representing the tokenized sentence in the form of word embeddings;
Mapping Data: data reflecting the mapping of word embeddings to sign language words;
Translation Output Data: data representing the final sequence of sign language words;
Letters Dictionary Table: a table mapping individual letters to their corresponding sign language images;
Words Dictionary Table: a table mapping words to their corresponding language images;
Human Agent Interaction Data: Data related to interactions with human agents and user feedback.

6. The method of claim 5, wherein the data storage platform includes:
Current Data Table: for storing ongoing translation data;
Historical Data Table: for archiving completed translations, new words, human agent interaction, and user feedback for further refinement.

7. A non-transitory computer-readable storage medium storing executable instructions that, when executed by a processor, cause a system to perform the method of translating complete sentences into Sign Language using word embeddings, comprising:
Receiving an input sentence;
Simplifying the sentence using a pre-trained LLM;
Tokenizing and representing the sentence with word embeddings;
Mapping the embeddings to sign language words;
Generating the sequence of sign language words;
Constructing a video from the sequence of sign language images to be displayed to the user;
Handling non-matching words by spelling them out or substituting with sign language when available.

8. The method of claim 1, further comprising:
Sign Language Image Dataset: a collection of labeled sign language images, each associated with corresponding sign language words;
Computer Vision Model Training Module: for training a computer vision model using the labeled sign language images to recognize and predict sign language words from new images;
Prediction Engine: for utilizing the trained computer vision model to output the necessary sign language image corresponding to a given word, enabling the construction of an answer video to be displayed to the client.
